(19) United States
(12) Patent Application Publication
(10) Pub. No.: US 2026/0028440 A1
(43) Pub. Date: Jan. 29, 2026

(54) Curable Composition for Producing Transparent Orthodontic Attachments

(71) Applicant: Solventum Intellectual Properties Company, Maplewood, MN (US)

(72) Inventors: Gioacchino Raia, Tuerkenfeld (DE); Reinhold Hecht, Schondorf am Ammersee (DE); Malte Korten, Moorenweis (DE); Daniel D. Oberpertinger, Herrsching (DE)

(21) Appl. No.: 18/994,310

(22) PCT Filed: Jun. 23, 2023
(86) PCT No.: PCT/IB2023/056518

§ 371 Date: Jan. 14, 2025

(30) Foreign Application Priority Data
Jul. 21, 2022 (EP) 22186138.8

(51) Int. Cl. C08F 283/00; A61C 7/28; C08F 2/44; C08F 2/50; C08K 3/36; C08K 5/00; C08K 5/13; C08K 5/3475; C08K 9/06

(52) U.S. Cl. CPC C08F 283/008; A61C 7/282; C08F 2/44; C08F 2/50; C08K 3/36; C08K 5/0041; C08K 5/13; C08K 5/3475; C08K 9/06; C08K 2201/005; C08K 2201/011

(57) ABSTRACT

The invention relates to a curable composition comprising a (meth)acrylate not comprising an urethane moiety, an urethane (meth)acrylate, photo-initiator, discrete filler particles having an average particle size in the range of 10 to 40 nm, having been surface treated with a silane surface treating agent selected from a silane surface treating agent comprising a (meth)acrylate moiety, a silane surface treating agent not comprising a (meth)acrylate moiety, and a mixture of both, and the discrete filler particles being present in an amount of 20 wt. % or more, the curable composition further comprising additives, the curable composition not comprising the following components alone or in combination: aggregates of nano-sized particles, agglomerates of nano-sized particles, fumed silica, each in an amount of 2 wt. % or more, wt. % with respect to the curable composition.

### FIELD OF INVENTION

The invention relates to a curable composition which can be processed in an additive-manufacturing process and which can be used for producing highly transparent orthodontic attachments for use in a dental aligner therapy.

### BACKGROUND

In today's dental aligner therapy, orthodontic attachments are used to support movement of teeth.

Currently light-curable composite materials are used for making these orthodontic attachments.

Based on the existing shades and formulations the orthodontic attachments are typically visible on the tooth surface and may compromise the overall aesthetics of the aligner therapy.

Further, as the orthodontic attachments have to fit to the individual tooth surfaces of the patient, the orthodontic attachments need to be produced customized. This is often very cumbersome.

WO 2021/130624 A1 (3M) describes e.g., articles, systems and techniques for manufacturing orthodontic attachments by an additive manufacturing process and positioning the attachments with the use of a transfer tray on a tooth surface.

WO 2019/048963 A1 (3M) relates to a radiation curable composition including a radiation hardenable component, a photo-initiator, and a filler material having a population of particulates in an amount greater than or equal to 50 wt. % of the printable composition. The population of particulates exhibit a median diameter (D50) of greater than or equal to 0.3 micrometer on a volume-average basis.

WO 2019/104072 A1 (3M) describes an orthodontic article comprising a cured composition comprising the reaction product of free-radically polymerizable resin comprising at least one monomer, oligomer and/or polymer comprising at least two (meth)acrylate moieties: a monofunctional reactive diluent; and a polymer comprising a free-radically photo-initiator group.

U.S. Pat. No. 9,795,541B2 (Fontein et al.) relates to the use of free-radically curable compositions, comprising chain-like and/or cyclic and/or cage-type polysiloxanes substituted by free-radically polymerizable groups and having at least 3 silicon atoms and/or mixed forms thereof, disiloxanes substituted by free-radically polymerizable groups, optionally one, two, three or more free-radically curable monomers having no silicon atom, fillers, initiators and/or catalysts for free-radical polymerization, and also further customary additives, in additive manufacturing methods, preferably in stereolithography (SL) and digital light processing (DLP).

### SUMMARY OF INVENTION

Thus, there is a need for a curable composition which can be processed using an additive-manufacturing process and which is suitable for producing customized orthodontic attachments for use e.g., in a dental aligner therapy.

A pleasant aesthetics of the cured composition in the oral cavity of a patient would be desirable.

Ideally, the cured composition should not be opalescent and have adequate physical-mechanical properties.

Further, if possible, the cured composition should also have a sufficient wearing comfort and be easy to clean.

One or more of these objectives can be achieved by the invention described in the present text and claims.

In one embodiment the invention features a curable composition described in the claims and the present text, the curable composition comprising a (meth)acrylate not comprising a urethane moiety, a urethane (meth)acrylate, photo-initiator, additives, discrete nano-sized filler particles having an average particle size in the range of 10 to 40 nm and having been surface treated with a silane surface treating agent selected from a silane surface treating agent comprising a (meth)acrylate moiety, a silane surface treating agent not comprising a (meth)acrylate moiety, and a mixture of both, the discrete nano-sized filler particles being present in an amount of 20 wt. % or more, the curable composition not comprising the following components alone or in combination: aggregates of nano-sized filler particles, agglomerates of nano-sized filler particles, fumed silica, each in an amount of 2 wt. % or more, wt. % with respect to the whole composition.

In particular, the curable composition described in the present text does not comprise polymerizable components comprising only one (meth)acrylate moiety in an amount of 1 wt. % or more, wt. % with respect to the curable composition and does not comprise filler particles other than those mentioned-above each in an amount of 2 wt. % or more.

In another embodiment, the invention relates to a cured composition obtainable by curing the curable composition described in claims and the present text, preferably by processing the curable composition in an additive manufacturing process.

Another embodiment of the invention relates to a cured composition for use in a method of aligning teeth, the method comprising the steps of attaching the cured composition described in the claims and the present text to the surface of a tooth located in the mouth of a patient with the aid of a dental positioning tray, removing the dental positioning tray, inserting a dental aligner tray into the mouth of the patient, the dental aligner tray being in engagement with the cured composition attached to the surface of the tooth, the cured composition having the shape of an orthodontic attachment, the orthodontic attachment having a transparency in the range of 60 to 85% determined with light having a wavelength in the range of 400 to 700 nm on a 1 mm thick sample, having a flexural strength of 50 to 200 MPa determined according to ISO 4049 (2019), and comprising a (meth)acrylate not comprising a urethane moiety, a urethane (meth)acrylate, and surface treated discrete filler particles in an amount of 20 to 50 wt. %.

A further embodiment, the invention relates to a process of producing an orthodontic attachment, the process comprising the step of processing the curable composition described in the claims and the present text with an additive-manufacturing process.

Yet a further embodiment of the invention is directed to a kit of parts comprising a dental positioning tray; and either at least one curable composition as described in the claims and the present text: or at least one cured composition as described in the claims and the present text, and optionally a dental aligner tray.

Unless defined differently, for this description the following terms shall have the given meaning:

The term “compound” or “component” is a chemical substance which has a certain molecular identity or is made of a mixture of such substances, e.g., polymeric substances.

A “hardenable or curable or polymerizable component” is any component which can be cured or solidified in the presence of a photo-initiator by radiation-induced polymerization. A hardenable component may contain only one, two, three or more polymerizable groups. Typical examples of polymerizable groups include unsaturated carbon groups, such as a vinyl group being present i.a. in a (methyl) acrylate group.

As used herein, “(meth)acryl” is a shorthand term referring to “acryl” and/or “methacryl”. For example, a “(meth)acryloxy” group is a shorthand term referring to either an acryloxy group (i.e., CH₂═CH—C(O)—O—) and/or a methacryloxy group (i.e., CH₂═C(CH₃)—C(O)—O—).

A “urethane group” is a group having the structure “—NH—CO—O—”.

As used herein, “hardening” or “curing” a composition are used interchangeably and refer to polymerization and/or crosslinking reactions including, for example, photo-polymerization reactions and chemical-polymerization techniques (e.g., ionic reactions or chemical reactions forming radicals effective to polymerize ethylenically unsaturated compounds) involving one or more materials included in the composition.

“Radiation curable” shall mean that the component (or composition, as the case may be) can be cured by applying radiation, preferably electromagnetic radiation with a wavelength in the light spectrum range of 350 to 500 nm under ambient conditions and within a reasonable time frame (e.g. within about 15, 10 or 5 min).

“Dental article” means an article which is to be used in the dental or orthodontic field. A dental article has typically two different surface portions, an outer surface and an inner surface. The outer surface is the surface which is typically not in permanent contact with the surface of a tooth. In contrast thereto, the inner surface is the surface which is used for attaching or fixing the dental article to a tooth. If the dental article has the shape of a dental crown, the inner surface has typically a concave shape, whereas the outer surface has typically a convex shape. A dental article should not contain components which are detrimental to the patient's health and thus free of hazardous and toxic components being able to migrate out of the dental or orthodontic article.

“Orthodontic article” includes orthodontic brackets, orthodontic attachments, buccal tubes, lingual retainers, orthodontic bands, bite openers, buttons, and cleats, in particular orthodontic brackets and orthodontic attachments.

A “particle” means a substance being a solid having a shape which can be geometrically determined. The shape can be regular or irregular. Particles can typically be analysed with respect to e.g. particle size and particle size distribution.

“Agglomerated” is descriptive of a weak association of particles usually held together by charge or polarity and can be broken down into smaller entities. The specific surface of agglomerated particles does not essentially deviate from the specific surface of the primary particles the agglomerate is made of (cf. DIN 53206; 1972).

Agglomerated fillers are commercially available e.g. from Degussa, Cabot Corp or Wacker under the product designation Acrosil™, CAB-O-SIL™ and HDK.

A “non-agglomerated or discrete filler particles” means that the filler particles are present in the resin in a discrete, un-associated (i.e. non-agglomerated and non-aggregated) stage. If desired this can be proven by TEM microscopy.

Non-agglomerated nano-sized silicas are commercially available e.g. from Nalco Chemical Co. (Naperville, Ill.) under the product designation NALCO™ COLLOIDAL SILICAS e.g. NALCO™ products #1040, 1042, 1050, 1060, 2327 and 2329.

Non-agglomerated fillers are used and described e.g., in U.S. Pat. No. 8,329,776B2 (Hecht et al.). The content of this reference is herewith incorporated by reference.

“Aggregated,” as used herein, is descriptive of a strong association of particles often bound together by, for example, residual chemicals treatment or partially sintering. The specific surface of aggregated particles is typically smaller than the specific surface of the primary particles the aggregate is made of (cf. DIN 53206; 1972).

“Additive manufacturing” or “3d-printing” means processes comprising a layer-wise creation of an object from digital data. The articles can be of almost any shape or geometry and are produced from a 3-dimensional model or other electronic data source.

Many 3d-printing technologies exist, one of them being vat polymerization which uses a radiation curing step to make 3-dimensional articles. Examples of vat polymerization techniques include stereolithography (SLA) and digital light processing (DLP).

“Stereolithography” is an example of an additive manufacturing technique where typically two motors are used for aiming a laser beam across the print area thereby solidifying the printing resin. This process breaks down the design, layer by layer, into a series of points.

“Digital light processing” is another example of an additive manufacturing technique and typically comprises the use of a digital projector screen to flash an image of each layer across the building platform of the additive manufacturing unit. The image is typically composed of square pixels, resulting in a layer formed from small rectangular bricks called voxels.

An article is considered “opalescent” if the calculated opalescent value OP meets the following condition:

$${{{OP = [ ( {ClEa}_{T} * - {ClEa}_{R} \text{*)}}^{2} + ( {ClEb}_{T} * - {CIEb}_{R} \text{*)}}^{2} ]}^{1 / 2} = 3 to 15 ,$$

wherein
(CIEaᵣ*−CIEa_{R}*) is the difference between transmission and reflectance modes in red-green coordinate a*, and
(CIEbᵣ*−CIEb_{R}*) is the difference between transmission and reflectance modes in yellow-blue color coordinate b*

The degree of opalescence can be quantified by a colorimetric spectrophotometry measurement with a CIE standard (cf. U.S. Pat. No. 6,232,367 (Kobashigawa et. al.).

“Ambient conditions” mean the conditions which the composition described in the present text is usually subjected to during storage and handling. Ambient conditions may, for example, be a pressure of 900 to 1,100 mbar, a temperature of 10 to 40° C. and a relative humidity of 10 to 100%. In the laboratory ambient conditions are typically adjusted to 20 to 25° C. and 1,000 to 1,025 mbar (at maritime level).

As used herein, “a”, “an”, “the”, “at least one” and “one or more” are used interchangeably. Also herein, the recitations of numerical ranges by endpoints include all numbers subsumed within that range (e.g., 1 to 5 includes 1, 1.5, 2, 2.75, 3, 3.80, 4, 5, etc.).

Adding an “(s)” to a term means that the term should include the singular and plural form. E.g. the term “additive(s)” means one additive and more additives (e.g. 2, 3, 4, etc.).

Unless otherwise indicated, all numbers expressing quantities of ingredients, measurement of physical properties such as described below and so forth used in the specification and claims are to be understood as being modified in all instances by the term “about”. The terms “comprise” or “contain” and variations thereof do not have a limiting meaning where these terms appear in the description and claims. “Consisting essentially of” means that specific further components can be present, namely those which do not materially affect the essential characteristic of the article or composition. “Consisting of” means that no further components should be present. The term “comprise” shall also include the terms “consist essentially of” and “consists of”.

A composition is “essentially or substantially free of” a certain component, if the composition does not contain said component as an essential feature. Thus, said component is not wilfully added to the composition either as such or in combination with other components or ingredient of other components. A composition being essentially free of a certain component usually does not contain that component at all. However, sometimes the presence of a small amount of the said component is not avoidable e.g., due to impurities contained in the raw materials used. “Essentially free of” typically means a content of less than 1, 0.5 or 0.1 wt. %.

### BRIEF DESCRIPTION OF FIGURES

FIG. 1 shows orthodontic attachments attached to a tooth surface for use in a dental aligner therapy according to the state of the art.

FIG. 2 shows 3d-printed orthodontic attachments with different transparencies, respectively different opalescence values, based on printing resins containing nano-sized particles with different average particle diameter or no filler.

FIG. 3 shows an orthodontic attachment produced with the curable composition described in the present text attached to a tooth surface.

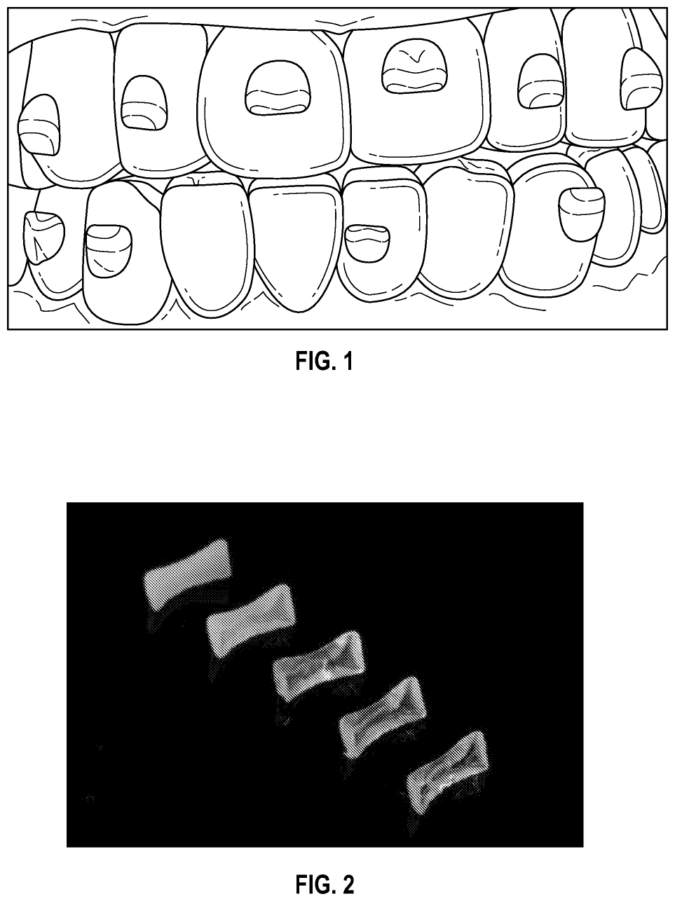

### DETAILED DESCRIPTION

It has been found that the composition and processes described in the present text have a couple of advantageous properties.

The curable composition can be processed in an additive-manufacturing process, i.e., the curable composition is 3d-printable.

Further, as the filler particles are in a discrete stage, the curable and also cured composition is highly transparent.

The cured composition is typically also not opalescent, which may further improve the transparency.

This is advantageous as the composition can be processed and cured in an additive-manufacturing process more easily and enables also the 3d-printing of small and filigree structures, like orthodontic articles.

Thus, the composition can be used for manufacturing orthodontic articles, which can be later attached to a tooth surface.

If desired, the orthodontic articles can be inserted in a positioning tray and applied to the tooth surface.

Further, due to its transparency or translucency and absence of opalescence the cured composition is highly aesthetic and orthodontic articles manufactured therefrom are hardly visible on a tooth surface.

In addition, an article obtained or obtainable after curing the curable composition has advantageous mechanical properties, in particular as regards flexural strength, E-modulus and/or deformation.

It was also found that the curable composition enables the production of a cured composition or article having a smooth surface. If the article has the shape of an orthodontic attachment to be used in the mouth of a patient this may provide a kind of “soft-feeling” effect and increases the wearing comfort.

A smooth surface is also easy to clean and as such contributes to avoiding staining and discoloration of the dental attachment over time.

The curable composition described in the present text can be characterized as one-part light-curable composition.

The curable composition can be further characterized by the following features alone or in combination: viscosity: <50 Pa*s at 23° C. a shear rate of 1 s⁻¹: or within a range of 1 to less than 50 Pa*s at 23° C. a shear rate of 1 s⁻¹: curable by radiation having a wavelength in the range of 350 to 500 nm or 350 to 420 nm.

A viscosity of the curable composition in the above range was found to be particular suitable for processing the curable composition in an additive-manufacturing process.

Due to the high transparency, there is less scattering of light which allows an easier producing of highly filigree articles.

The curable composition comprises one or more (meth)acrylate components not comprising a urethane moiety.

The (meth)acrylate(s) not comprising a urethane moiety is different from a urethane (meth)acrylate, e.g., with respect to functionality, chemical moieties, molecular weight, or combinations thereof.

The (meth)acrylate components not comprising a urethane moiety can typically be characterized by the following properties alone or in combination: comprising at least 2 (meth)acrylate moieties: molecular weight (Mw): 170 to 1,000 g/mol.

Examples include di-or poly-acrylates and methacrylates such glycerol diacrylate, glycerol triacrylate, ethyleneglycol diacrylate, diethyleneglycol diacrylate, triethyleneglycol dimethacrylate, 1,3-propanediol diacrylate, 1,3-propanediol dimethacrylate, trimethylolpropane triacrylate, 1,2,4-butanetriol trimethacrylate, 1,4-cyclohexanediol diacrylate, pentaerythritol triacrylate, pentaerythritol tetraacrylate, pentaerythritol tetramethacrylate, sorbitol hexacrylate, bis[1-(2-acryloxy)]-p-ethoxyphenyldimethylmethane, bis[1-(3-acryloxy-2-hydroxy)]-p-propoxyphenyl-dimethylmethane: the bis-acrylates and bis-methacrylates of polyethylene glycols of molecular weight 200-500 g/mol, copolymerizable mixtures of acrylated monomers such as those in U.S. Pat. No. 4,652,274, and acrylated oligomers such as those of U.S. Pat. No. 4,642,126; and vinyl compounds such as diallyl phthalate, divinyl succinate, divinyl adipate and divinylphthalate.

Preferred ethylenically unsaturated monomers are methacrylate and acrylate monomers, such as di(meth)acrylates of propanediol, butanediol, hexanediol, octanediol, nonanediol, decanediol and eicosanediol, di(meth)acrylates of ethylene glycol, of polyethylene glycols and of polypropylene glycols, di(meth)acrylates of ethoxylated bisphenol A, for example 2,2′-bis(4-(meth)acryl-oxytetraethoxyphenyl) propanes, and (meth)acrylamides. The monomers used can furthermore be esters of [alpha]-cyanoacrylic acid, crotonic acid, cinnamic acid and sorbic acid.

It is also possible to use methacrylic esters such as those mentioned in U.S. Pat. No. 4,795,823 (Schmitt et al.), including bis[3[4]-methacryl-oxymethyl-8(9)-tricyclo[5.2.1.0^{2.6}]decylmethyl triglycolate. Particularly suitable are 2,2-bis-4(3-methacryloxy-2-hydroxypropoxy)phenylpropane (Bis-GMA), 2.2-bis-4 (3-methacryloxypropoxy)phenylpropane, triethylene glycol dimethacrylate (TEGDMA), and di(meth)acrylates of bishydroxymethyltricyclo-(5.2.1.0^{2.6}) decane.

The (meth)acrylate components not comprising a urethane moiety is typically present in the following amounts: at least 20, or at least 25, or at least 30 wt. %; or at most 75, or at most 70, or at most 65 wt. %; or from 20 to 75, or 25 to 70, or 30 to 65 wt. %: wt. % with respect to the whole composition.

The curable composition comprises one or more urethane (meth)acrylates. The urethan (meth)acrylate typically comprises at least two (meth)acrylate moieties and at least two urethane moieties.

The molecular weight (Mw) of the urethane (meth)acrylate is at least 400 g/mol or at least 800 g/mol or at least 1,000 g/mol. Useful ranges include from 400 to 3,000 g/mol or from 800 to 2,700 g/mol or from 1,000 to 2,500 g/mol.

The urethane (meth)acrylates employed in the composition are typically obtained by reacting an NCO-terminated compound with a suitable monofunctional (meth)acrylate monomer such as hydroxyethyl acrylate, hydroxyethyl methacrylate, hydroxypropylmethacrylate, preferably hydroxyethyl-and hydroxypropylmethacrylate.

Urethane (meth)acrylates may be obtained by a number of processes known to the skilled person.

For example, a polyisocyanate and a polyol may be reacted to form an isocyanate-terminated urethane prepolymer that is subsequently reacted with a (meth)acrylate such as 2-hydroxy ethyl (meth)acrylate. These types of reactions may be conducted at room temperature or higher temperature, optionally in the presence of catalysts such as tin catalysts, tertiary amines and the like.

Polyisocyanates which can be employed to form isocyanate-functional urethane prepolymers can be any organic isocyanate having at least two free isocyanate groups. Included are aliphatic cycloaliphatic, aromatic and araliphatic isocyanates.

Any of the known polyisocyanates such as alkyl and alkylene polyisocyanates, cycloalkyl and cycloalkylene polyisocyanates, and combinations such as alkylene and cycloalkylene polyisocyanates can be employed.

Preferably, diisocyanates having the formula X(NCO)₂ are used, with X representing an aliphatic hydrocarbon radical with 2 to 12 C atoms, a cycloaliphatic hydrocarbon radical with 5 to 18 C atoms, an aromatic hydrocarbon radical with 6 to 16 C atoms and/or an araliphatic hydrocarbon radical with 7 to 15 C atoms.

Examples of suitable polyisocyanates include 2,2,4-trimethylhexamethylene-1,6-diisocyanate, hexamethylene-1,6-diisocyanate (HDI), cyclohexyl-1,4-diisocyanate, 4,4′methylene-bis(cyclohexyl isocyanate), 1,1′-methylenebis(4-isocyanato) cyclohexane, isophorone diisocyanate, 4,4′-methylene diphenyl diisocyanate, 1,4-tetramethylene diisocycanate, meta- and para-tetra-methylxylene diisocycanate, 1,4-phenylene diisocycanate, 2,6- and 2,4-toluene diisocycanate, 1,5-naphthylene diisocycanate, 2,4′ and 4,4′-diphenylmethane diisocycanate and mixtures thereof.

It is also possible to use higher-functional polyisocyanates known from polyurethane chemistry or else modified polyisocyanates, for example containing carbodiimide groups, allophanate groups, isocyanurate groups and/or biuret groups. Particularly preferred isocyanates are isophorone diisocyanate, 2,4,4-trimethyl-hexamethylene diisocyanate and higher-functional polyisocyanates with isocyanurate structure.

The isocyanate terminated urethane compound is capped with a (meth)acrylate to produce a urethane (meth)acrylate compound. In general, any (meth)acrylate-type capping agent having a terminal hydroxyl group and also having an acrylic or methacrylic moiety can be employed, with the methacrylic moiety being preferred.

Examples of suitable capping agents include 2-hydroxyethyl (meth)acrylate, 2-hydroxypropyl (meth)acrylate, glycerol di(meth)acrylate and/or trimethylolpropane di(meth)acrylate. Particularly preferred are 2-hydroxyethyl methacrylate (HEMA) and/or 2-hydroxyethyl acrylate (HEA).

The equivalence ratio of isocyanate groups to compounds reactive vis-à-vis isocyanate groups is 1.1:1 to 8:1, preferably 1.5:1 to 4:1.

The isocyanate polyaddition reaction can take place in the presence of catalysts known from polyurethane chemistry, for example organotin compounds such as dibutyltin dilaurate or amine catalysts such as diazabicyclo[2.2.2]octane. Furthermore, the synthesis can take place both in the melt or in a suitable solvent which can be added before or during the prepolymer preparation. Suitable solvents are for example acetone, 2-butanone, tetrahydrofurane, dioxane, dimethylformamide, N-methyl-2-pyrrolidone (NMP), ethyl acetate, alkyl ethers of ethylene and propylene glycol and aromatic hydrocarbons. The use of ethyl acetate as solvent is particularly preferred.

Suitable examples of urethane (meth)acrylates include 7,7,9-trimethyl-4,13-dioxo-3,14-dioxa-5,12-diazahexadecane-1,16-dioxy-dimethacrylate (e.g. Plex 666-1, Röhm), urethane (meth)-acrylates derived from 1,4 and 1,3-Bis(1-isocyanato-1-methylethyl)benzene (e.g., as described in EP 0 934 926 A1) and mixtures thereof.

According to one embodiment, the urethane (meth)acrylate is characterized as follows:

having the structure A-(-S1-U-S2-MA), with

A being a connector element comprising at least one unit,

S1 being a spacergroup comprising at least 4 units connected with each other,

S2 being a spacergroup comprising at least 4 units connected with each other,
the units of A, S1 and S2 being independently selected from CH₃—, —CH₂—, —O—, —S—, —NR¹—, —CO—, —CR¹═,

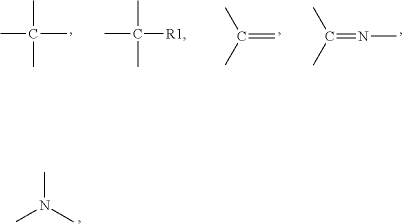

—N═, —CR¹R²—,
with R1 and R2 being independently selected from hydrogen, alkyl, substituted alkyl, alkenyl, cycloalkyl, substituted cycloalkyl, arylalkyl, aryl or substituted aryl, wherein these units can form linear, branched or cyclic structures such as alkyl, cycloalkyl, aryl, ester, urethane or amide groups,
U being a urethane group connecting spacergroups S1 and S2,
MA being an acrylate or methacrylate group and
n being 3 to 6.

According to one embodiment the urethane (meth)acrylate is represented by the structure

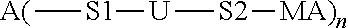

with
A being a connector element comprising at least 1, 2, 3, 4, 5, 6, 7, 8, 9, 10, 11, 12, 13, 14, 15, 16, 17, 18, 19 or 20 units,
S1 being a spacergroup comprised of units connected with each other and comprising at least 4, 5, 6, 7, 8, 9 or 10 units,
S2 being a spacergroup comprised of units connected with each other and comprising at least 4, 5, 6, 7, 8, 9, 10, 12, 15, 20 or 25 units,
U being a urethane group connecting spacergroups S1 and S2,
MA being an acrylate or methacrylate group and
n being 3 to 6 or 4 to 6 or 5 to 6.

It can be preferred, if A has a cyclic structure and comprises at least about 6 units.

It can further be preferred, if S1 has a linear or branched structure and comprises at least 4 or 6 units.

It can further be preferred, if S2 has a linear or branched structure and comprises at least 6 or 8 units.

A urethane (meth)acrylate wherein A has a cyclic structure and comprises at least 6 units and S1 has a linear structure and comprises at least 4 units and S2 has a linear structure and comprises at least 8 units and U is a urethane group can also be preferred.

Neither the atoms of the urethane group connecting S1 and S2 nor the atoms of the (meth)acrylgroup belong to the spacergroup S1 or S2. Thus, the atoms of the urethane group do not count as units of the spacergroups S1 or S2.

The nature and structure of the connector element is not particularly limited. The connector element can contain saturated (no double bonds) or unsaturated (at least one or two double bonds) units, aromatic or hetero aromatic units (aromatic structure containing atoms including N, O and S).

Specific examples of connector element A having a cyclic structure include:

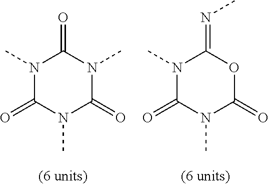

Specific examples of connector element A having a non-cyclic but branched structure include:

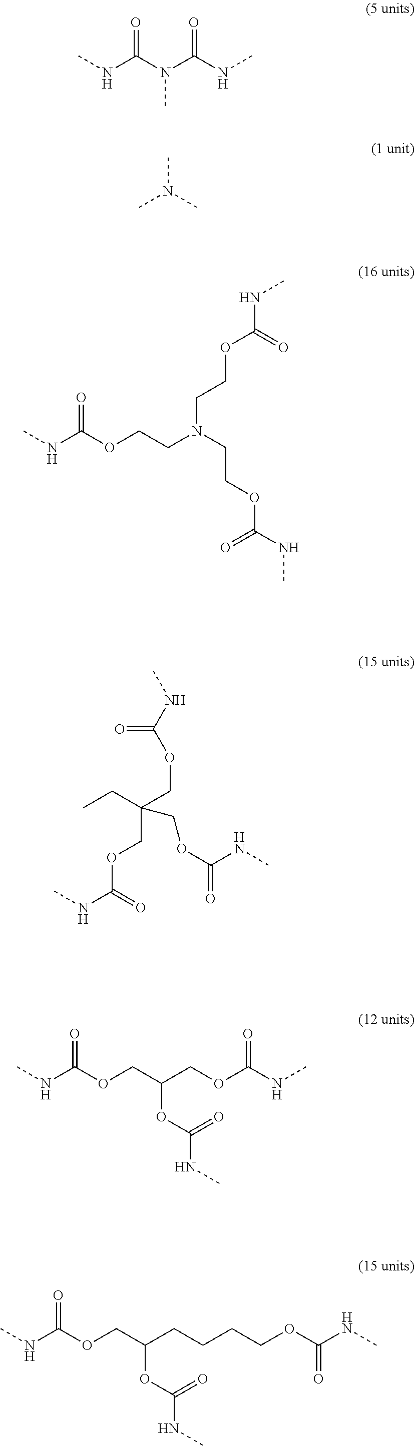

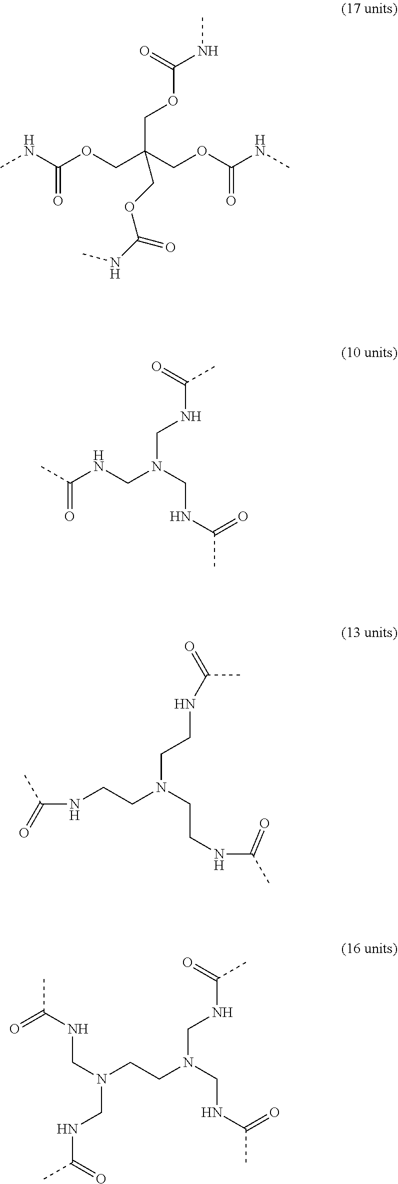

The dotted lines indicate the bondings to the spacergroup S1.

The nature and structure of the spacergroups S1 or S2 is not particularly limited, either.

The spacergroups are comprised of units connected with each other. Typical units include:
CH₃—, —CH₂—, —O—, —S—, —NR¹—, —CO—, —CR¹═,

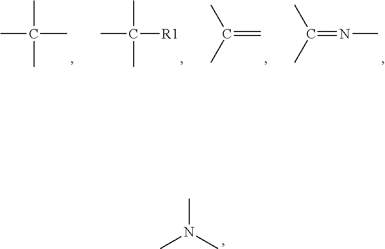

—N═, —CR¹R², with R¹ and R² independently selected from hydrogen, alkyl, substituted alkyl, alkenyl, cycloalkyl, substituted cycloalkyl, arylalkyl, aryl or substituted aryl.

These units can form linear, branched or cyclic structures such as alkyl, cycloalkyl, aryl, ester, urethane or amide groups.

The structure of S1 can be identical to the structure of S2. However, in some embodiments the structure of S1 is different from S2. In a specific embodiment the number of units being present in S1 is less or equal than the number of units being present in S2.

In a specific embodiment, S1 may have a saturated hydrocarbon structure.

In another specific embodiment, S2 may have a saturated hydrocarbon structure.

Typical examples of useful spacer groups for S1 include:

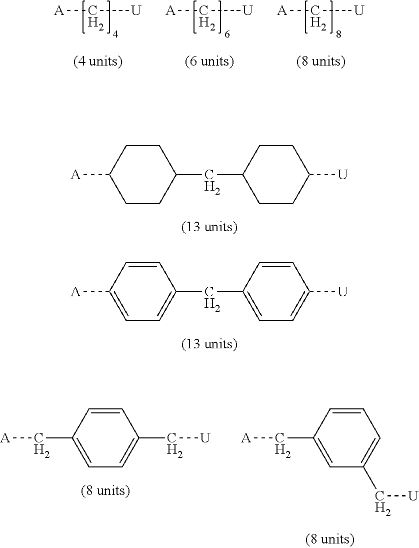

The dotted lines indicate the chemical bonding to either the group A or the group U.

Typical examples of useful spacer groups for S2 include:

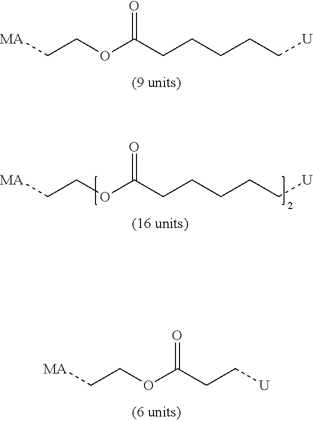

The dotted lines indicate the chemical bonding to either the (meth)acrylate group or the group U. The number of the units to be counted according to the invention is given in brackets.

Specific examples of the urethane (meth)acrylate include:

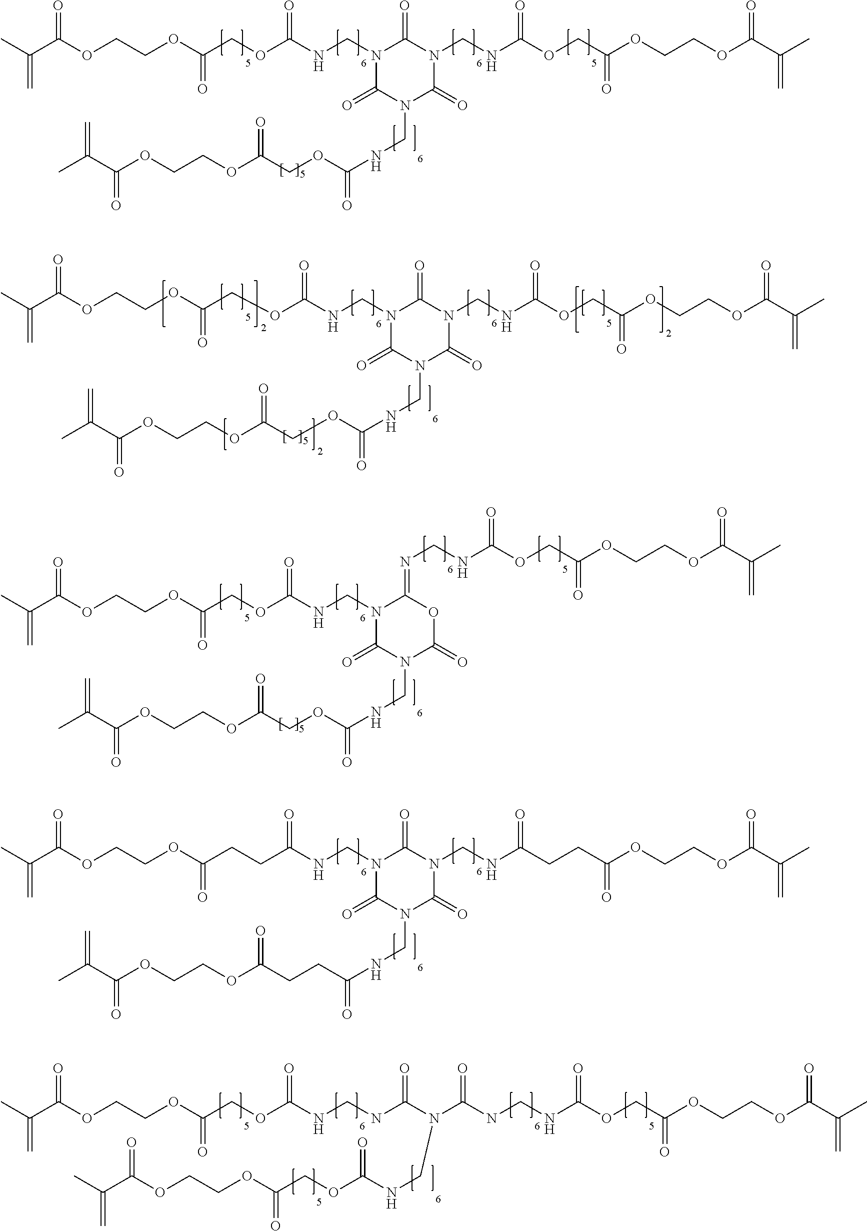

Further suitable urethane (meth)acrylates are based on alpha-omega-terminated poly(meth)acrylatdiols (e.g., as described in EP 1 242 493B1) or can be a polyester, polyether, polybutadiene or polycarbonate urethane (meth)acrylate (e.g., as described in U.S. Pat. No. 6,936,642 B2). The urethane (meth)acrylate is typically present in the following amounts: at least 5, or at least 8, or at least 10 wt. %; or at most 25, or at most 20, or at most 15 wt. %; or from 5 to 25, or 8 to 20, or 10 to 15 wt. %; wt. % with respect to the whole composition.

The (meth)acrylate not comprising a urethane moiety is typically used in excess over the (meth)acrylate comprising a urethane moiety by weight.
The ratio of ((meth)acrylate not comprising a urethane moiety)/((meth)acrylate comprising a urethane moiety) is typically in a range of 10/1 to 2/1 with respect to weight.

The curable composition comprises a photo-initiator. If desired, one or more photo-initiators can be used.

For processing the curable composition in an additive-manufacturing process, the photo-initiator should have a light absorption peak in the range of 350 to 500 nm.

Suitable photo-initiators include acylphosphine oxides.

Acylphosphine oxides can be characterized by the following formula

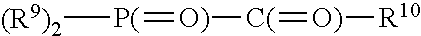

wherein each R⁹ individually can be a hydrocarbyl group such as alkyl, cycloalkyl, aryl, and aralkyl, any of which can be substituted with a halo-, alkyl- or alkoxy-group, or the two R⁹ groups can be joined to form a ring along with the phosphorous atom, and wherein R¹⁰ is a hydrocarbyl group, an S—, O—, or N-containing five- or six-membered heterocyclic group, or a —Z—C(═O)—P(═O)—(R⁹)₂ group, wherein Z represents a divalent hydrocarbyl group such as alkylene or phenylene having 2 to 6 carbon atoms.

Suitable systems are also described e.g., in U.S. Pat. No. 4,737,593 (Ellrich et al.), the content of which is herewith incorporated by reference.

Preferred acylphosphine oxides are those in which the R⁹ and R¹⁰ groups are phenyl or lower alkyl- or lower alkoxy-substituted phenyl. By “lower alkyl” and “lower alkoxy” is meant such groups having from 1 to 4 carbon atoms. In particular. 2.4.6-trimethylbenzoyl diphenyl phosphine oxide was found to be useful (Lucirin™ TPO. BASF).

More specific examples include: bis-(2.6-dichlorobenzoyl)phenylphosphine oxide, bis-(2.6-dichlorobenzoyl)-2.5-dimethylphenylphosphine oxide, bis-(2.6-dichlorobenzoyl)-4-ethoxyphenyl-phosphine oxide, bis-(2.6-dichlorobenzoyl)-4-biphenylylphosphine oxide, bis-(2.6-dichloro-benzoyl)-4-propylphenylphosphine oxide, bis-(2.6-dichlorobenzoyl)-2-naphthylphosphine oxide, bis-(2.6-dichlorobenzoyl)-1-napthylphosphine oxide, bis-(2.6-dichlorobenzoyl)-4-chloro-phenylphosphine oxide, bis-(2.6-dichlorobenzoyl)-2.4-dimethoxyphenylphosphine oxide, bis-(2.6-dichlorobenzoyl) decylphosphine oxide, bis-(2.6-dichlorobenzoyl)-4-octylphenylphosphine oxide, bis-(2.6-dimethoxybenzoyl)-2.5-dimethylphenylphosphine oxide, bis-(2.6-dimethoxybenzoyl)-phenylphosphine oxide, bis-(2.4.6-trimethylbenzoyl)-2.5-dimethylphenylphosphine oxide, bis-(2.6-dichloro-3.4.5-trimethoxybenzoyl)-2.5-dimethylphenylphosphine oxide, bis-(2.6-dichloro-3.4.5-trimethoxy benzoyl)-4-ethoxyphenylphosphine oxide, bis-(2-methyl-1-naphthoyl)-2.5-dimethyl-phenylphosphine oxide, bis-(2-methyl-1-naphthoyl)phenylphosphine oxide, bis-(2-methyl-1-naphthoyl)-4-biphenylylphosphine oxide, bis-(2-methyl-1-naphthoyl)-4-ethoxyphenylphosphine oxide, bis-(2-methyl-1-naphthoyl)-2-naphthylphosphine oxide, bis-(2-methyl-1-naphthoyl)-4-propylphenylphosphine oxide, bis-(2-methyl-1-naphthoyl)-2.5-dimethylphosphine oxide, bis-(2-methoxy-1-naphthoyl)-4-cthoxyphenylphosphine oxide, bis-(2-methoxy-1-naphthoyl)-4-biphenylylphosphine oxide, bis-(2-methoxy-1-naphthoyl)-2-naphthylphosphine oxide and bis-(2-chloro-1-naphthoyl)-2.5-dimethylphenylphosphine oxide.

The acylphosphine oxide bis(2.4.6-trimethylbenzoyl)phenyl phosphine oxide (previously known as IRGACURE™ 819 from Ciba Specialty Chemicals) is sometimes preferred.

Suitable photo-initiators also include binary and tertiary photo-initiator systems. Typical tertiary photo-initiators include a iodonium salt, a photosensitizer and an electron donor compound as described in U.S. Pat. No. 5,545,676 (Palazzotto et al.). Suitable iodonium salts include the diaryl iodonium salts e.g., diphenyliodonium chloride, diphenyliodonium hexafluorophosphate and diphenyliodonium tetrafluoroborate. Suitable photosensitizers are monoketones and diketones.

Particularly suitable photosensitizers include alpha diketones. Examples include camphorchinone. benzil. 3.3.6.6-tetramethyl-cyclohexanedione, phenanthraquinone. 1-phenyl-1.2-propanedione and other 1-aryl-2-alkyl-1.2-ethandiones and cyclic alpha diketones. Suitable electron donor compounds include substituted amines. Especially tertiary amines are generally used.

Besides the photo-initiator, a reducing agent might be present. The combination of a photo-initiator and a reducing agent is often referred to as photo-initiator system. As reducing agent or donor component, tertiary amines are generally used.

Suitable examples of the tertiary amines include N,N-dimethyl-p-toluidine, N,N-dimethyl-aminoethyl methacrylate, triethanolamine, methyl 4-dimethylaminobenzoate, ethyl 4-dimethyl-aminobenzoate, methyldiphenylamine and isoamyl 4-dimethylaminobenzoate.

The photo-initiator is typically present in the following amount: at least 0.01, or at least 0.02, or at least 0.03 wt. %: or utmost 5, or utmost 4, or utmost 3 wt. %; or from 0.01 to 5 or 0.02 to 4 or 0.03 to 3 wt. %: wt. % with respect to the weight of the composition.

The curable composition comprises discrete nano-sized filler particles.

The average particle size of the discrete nano-sized filler particles is 40 nm and below, or 35 nm and below, or 30 nm and below. The average particle size is typically in a range of 10 to 40 nm or 10 to 35 or 10 to 30 nm.

The discrete nano-sized filler particles typically comprise oxides of Si, Zr, Al and mixtures thereof, wherein the oxides of Si and Zr are sometimes preferred.

The specific surface area (BET) of the nano-sized filler particles is preferably 80 m²/g or more, or 100 m²/g or more or 120 m²/g or more. The specific surface area (BET) is typically in a range of 80 to 500 m²/g or 100 to 400 m²/g or 120 to 300 m²/g. If desired, the specific surface can be determined according to Brunauer, Emmet and Teller (BET) by using a device (Monosorb™) available from Quantachrome.

Preferred nano-sized silicas are commercially available from Nalco Chemical Co. (Naperville, Ill.) under the product designation NALCO™ COLLOIDAL SILICAS. For example, preferred silica particles can be obtained from using NALCO™ products 1040, 1042, 1050, 1060, 2327 and 2329. Other suitable nano-sized silicas are commercially available from Covestro (Leverkusen, Germany) under the product designation Dispercoll™ (for example Dispercoll™ S 3030 or Dispercoll™ S 4020), Grace GmbH & Co. KG (Worms, Germany) under the product designation Ludox™ (for example Ludox™ P-X30 or Ludox™ P-W30) and Nouryon (Amsterdam, Netherlands) under the product designation Levasil™ (for example Levasil™ CS50-34P).

The discrete nano-sized filler particles are surface treated. Useful surface treatment agents are silanes.

The silane surface treating agents can comprise a polymerizable moiety or may not comprise a polymerizable moiety, in particular a (meth)acrylate moiety. Only one silane surface treating agent or mixtures of different silane treating agents can be used.

In a specific embodiment a mixture of a silane surface treating agent comprising a polymerizable moiety, in particular a (meth)acrylate moiety, and a silane surface treating agent not comprising a polymerizable moiety is used.

Surface treating allows an easier dispersing of the nano-sized filler particles in the monomer matrix and may prevent settling of the fillers from the formulation during storage.

If the surface treating is done with two different silane surface treating agents, the polymerizable silane surface treating agent is used in a higher amount with respect to weight compared to the non-polymerizable silane surface treating agent.

A ratio of the polymerizable silane surface treating agent to the non-polymerizable silane surface treating agent in the range of 90/10 to 60/40 or 80/20 to 70/30 with respect to weight was found to be useful.

If desired, the surface of the treated particles can be analysed using FT-IR or NMR technologies.

The polymerizable silane surface treating agent is usually an alkoxy silane, preferably a trialkoxy silane comprising a (meth)acrylate group.

Typical embodiments can be characterized by the following formula:

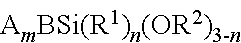

with A comprising a (meth)acryl moiety,
B comprising a spacer group, such as (i) linear or branched C₁ to C₁₂ alkyl, (ii) C₆ to C₁₂ aryl, (iii) organic group having 2 to 20 carbon atoms bonded to one another by one or more ether, thioether, ester, thioester, thiocarbonyl, amide, urethane, carbonyl and/or sulfonyl linkages,
R¹ comprising an alkyl group (e.g. C to C₆) or an aryl group (e.g. C₆ to C₁₂), and
R² comprising an alkyl group (e.g. C₁ to C₆),
with m=1, 2, or 3, and n=0, 1 or 2.

Examples of (meth)acrylate functionalized trialkoxy silanes include, but are not limited to 3-(meth)acryloxypropyl trimethoxysilane, 3-(meth)acryloxypropyl triethoxysilane, 3-(meth)-acryloxypropyl tris(methoxyethoxy) silane, 3-(meth)acryloxypropenyl trimethoxysilane, (meth)-acryloxyethyldimethyl (3-trimethoxysilylpropyl) ammonium chloride, N-(3-(meth)acryloxy-2-hydroxypropyl)-3-aminopropyltriethoxysilane, O-((meth)acryloxyethyl)-N-(triethoxysilylpropyl)-urethane, (meth)acryloxymethyl trimethoxysilane, (meth)acryloxymethyl;l triethoxysilane, (meth)acryloxymethyl methyldimethoxysilane, (meth)acryloxymethyl methyldiethoxysilane, (meth)acryloxyoctyl trimethoxysilane, [(meth)acryloxymethyl]phenethyl trimethoxysilane, O-[(meth)acryloxyethyl]-N-(triethoxysilylpropyl) carbamate, (meth)acryloxypropyl triisopropoxy-silane, (meth)acryloxypropyl methyldimethoxysilane, (meth)acryloxypropyl methyldiethoxysilane, 3-(meth)acryloxypropyl dimethylmethoxysilane, 3-(meth)acryloxypropyl dimethylethoxysilane, (meth)acryloxymethyl dimethylmethoxysilane, (meth)acryloxymethyl dimethylethoxysilane, oligomeric hydrolysate of 3-(meth)acryloxypropyl trimethoxysilane, oligomeric hydrolysate of 3-(meth)acryloxypropyl triethoxysilane.

The non-polymerizable silane surface treating agent is usually an alkoxy silane, preferably a trialkoxy silane.

Typical embodiments can be characterized by the following formula:

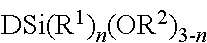

with D comprising (i) a linear or branched non-substituted or substituted (e.g., with one or more amino or mercapto groups) C₁ to C₁₆ alkyl, (ii) a non-substituted or substituted (e.g., with one or more amino or mercapto groups) C₆ to C₁₂ aryl group or (iii) an organic group having 2 to 20 carbon atoms bonded to one another by one or more ether, thioether, ester, thioester, thiocarbonyl, amide, urethane, carbonyl and/or sulfonyl linkages,

R¹ comprising an alkyl group (e.g., C₁ to C₆) or an aryl group (e.g., Co to C₁₂), and
R² comprising an alkyl group (e.g., C, to C₆),
with n=0, 1 or 2.

Suitable non-polymerizable silane surface treating agents include phenyltrimethoxy silane, phenyltriethoxy silane, octyltrimethoxy silane, octyltriethoxy silane, hexadecyltrimethoxy silane, isobutyltrimethoxy silane, isobutyltriethoxy silane, propyltrimethoxy silane, 3-aminopropyl-methyldiethoxy silane, 3-aminopropyltrimethoxy silane, 3-mercaptopropyltrimethoxy silane, N-(2-aminoethyl)-3-aminopropyltrimethoxy silane, N-cyclohexyl-3-aminopropyltrimethoxy silane, 3-ureidopropyltrimethoxy silane, (cyclohexyl)methyldimethoxy silane and mixtures thereof.

Polymerizable and non-polymrizable silane surface treating agents are commercially available e.g. from Wacker (München, Germany) under the product designation Geniosil™ or from Evonik (Hanau, Germany) under the product designation Dynasylan™

The process for surface treating discrete nano-sized filler particles typically comprises the following steps:
mixing a sol containing nano-sized particles with a silane surface treating agent and stirring the mixture under reflux in solvent like ethanol for several hours (e.g., 2 to 10 hrs):
after stirring for several hours (e.g., 2 to 10 hrs) undermixing of monomer into resulting mixture and stirring again for several hours (e.g., 2 to 10 hrs.) removing solvent under vacuum.

A suitable process is also described in U.S. Pat. No. 6,899,948 (Zhang et al.).

The curable composition does not comprise filler particles other than those described in the present text in an amount of 2 wt. % or more each.

In particular, the following filler components are not present alone or in combination: aggregates of nano-sized filler particles: agglomerates of nano-sized filler particles: fumed silica, wherein the average particle size of the primary filler particles is in the range of 10 to 40 nm.

Thus, the curable composition is essentially free of fillers comprising clusters of nano-sized filler particles, fumed silica and mixtures thereof.

It was found that the presence of those filler components may have an undesired effect on rheology, transparency and/or opacity.

The discrete nano-sized filler particles are typically present in the following amounts: at least 20, or at least 25, or at least 30 wt. %; or at most 50, or at most 45, or at most 40 wt. %; or from 20 to 50, or 25 to 45, or 30 to 40 wt. %: wt. % with respect to the whole composition.

Using such amounts of fillers typically contributes to the physical-mechanical properties of the composition, in particular in its cured state.

The curable composition typically also comprises one or more additives.

Additives which can be present include stabilizers, fluorescent dyes, UV light absorbers, and mixtures thereof.

Suitable stabilizers include free radical scavengers such as substituted and/or unsubstituted hydroxyaromatics (e.g, butylated hydroxytoluene (BHT), hydroquinone, hydroquinone monomethyl ether (MEHQ), 3,5-di-tert-butyl-4-hydroxyanisole (2,6-di-tert-butyl-4-ethoxyphenol), 2,6-di-tert-butyl-4-(dimethylamino)methylphenol or 2,5-di-tert-butyl hydroquinone, 2-(2′-hydroxy-5′-methylphenyl)-2H-benzotriazole, 2-(2′-hydroxy-5′-t-octylphenyl)-2H-benzotriazole, 2-hydroxy-4-methoxybenzophenone (UV-9), 2-(2′-hydroxy-4′,6′-di-tert-pentylphenyl)-2H-benzotriazole, 2-hydroxy-4-n-octoxybenzophenone, 2-(2′-hydroxy-5′-methacryloxyethylphenyl)-2H-benzotriazole, phenothiazine, and HALS (hindered amine light stabilizers).

Suitable fluorescent dyes often include an anthracene or perylene moiety.

Fluorescent dyes typically have an absorption peak in the range of 350 to 450 nm.

Commercially available fluorescent dyes include e.g., Lumilux™ Blau LZ, Lumilux™ Gelb LZ, and dyes comprising an anthracene moiety (e.g., 2-Ethyl-9,10-dimethoxyanthracene: EDMO). If present, fluorescent dyes are typically present in an amount of 0.001 to 0.5 wt. % with respect to the weight of the composition.

Suitable UV light absorbers include components comprising a benzotriazole moiety. UV absorbers typically have an absorption peak in the range of 350 to 420 nm.

Commercially available UV light absorbers include Tinuvin™ 326, Tinuvin™ 328, Tinuvin™ P, Uvinul™ M40.

If present, UV light absorbers are typically present in an amount of 0.001 to 1.0 wt. % with respect to the weight of the composition.

Additives are typically present in the following amounts: at least 0.001 or at least 0.01 or at least 0.1 wt. %; or utmost 10 or 7.5 or 5 wt. %; or from 0.001 to 10 or 0.01 to 7.5 or 0.1 to 5 wt. %; wt. % with respect to the whole composition.

The curable composition described in the present text does typically not comprise the following components alone or in combination: polymerizable components comprising an acidic moiety in an amount of 1 wt. % or more: polymerizable components comprising only one (meth)acrylate moiety in an amount of 1 wt. % or more: plasticizers in an amount of 1 wt. % or more: wt. % with respect to the weight of the curable composition. Thus, the curable composition is essentially free of these components.

The presence of e.g. polymerizable components comprising only one (meth)acrylate moiety in an amount of 1 wt. % or more may have an undesired impact on mechanical properties like E-modulus. Compositions comprising polymerizable components comprising only one (meth)acrylate moiety in an amount of 1 wt. % or more are sometimes considered too flexible.

The curable composition described in the present text typically comprises, essentially consist of, or consist of the respective components in the following amounts:
methacrylate not comprising a urethane moiety: 20 to 75 wt. %,
urethane (meth)acrylates: 5 to 25 wt. %,
photo-initiator: 0.01 to 5 wt. %,
discrete surface treated nano-sized filler particles: 20 to 50 wt. %,
additives: 0.001 to 10 wt. %, wt. % with respect to the whole composition.

The curable composition may also comprise, essentially consist of, or consist of the respective components also in the following amounts:
methacrylate not comprising a urethane moiety: 25 to 70 wt. %,
urethane (meth)acrylates: 8 to 20 wt. %,
photo-initiator: 0.02 to 4 wt. %,
discrete surface treated nano-sized filler particles: 25 to 45 wt. %,
additives: 0.01 to 7.5 wt. %, wt. % with respect to the whole composition.

The curable composition may also comprise, essentially consist of, or consist of the respective components also in the following amounts:
methacrylate not comprising a urethane moiety: 30 to 65 wt. %,
urethane (meth)acrylates: 10 to 15 wt. %,
photo-initiator: 0.03 to 3 wt. %,
discrete surface treated nano-sized filler particles: 30 to 40 wt. %,
additives: 0.1 to 5 wt. % wt. %, with respect to the whole composition.

More specific embodiments of the curable composition are given below:

### Embodiment 1

A curable composition comprising, consisting essentially of, or consisting of
a. a (meth)acrylate not comprising a urethane moiety in an amount of 20 to 75 wt. %,
b. a urethane (meth)acrylate in an amount of 5 to 25 wt. %,
c. photo-initiator,
d. discrete nano-sized filler particles
   having an average particle size in the range of 10 to 40 nm,
   having been surface treated with a silane surface treating agent selected from
      a silane surface treating agent comprising a (meth)acrylate moiety,
      a silane surface treating agent not comprising a (meth)acrylate moiety, and
      a mixture of both, and
   the discrete nano-sized filler particles being present in an amount of 20 wt. % to 50 wt. %,
e. additives, the curable composition not comprising the following components alone or in combination:
   aggregates of nano-sized filler particles,
   agglomerates of nano-sized filler particles,
   fumed silica,
each in an amount of 2 wt. % or more, wt. % with respect to the whole composition.

### Embodiment 2

A curable composition comprising, consisting essentially of, or consisting of
a. a (meth)acrylate not comprising a urethane moiety in an amount of 20 to 75 wt. %,
b. a urethane (meth)acrylate in an amount of 8 to 20 wt. %,
c. photo-initiator,
d. discrete nano-sized filler particles
   having an average particle size in the range of 10 to 40 nm,
   having been surface treated with a silane surface treating agent selected from
      a silane surface treating agent comprising a (meth)acrylate moiety,
      a silane surface treating agent not comprising a (meth)acrylate moiety, and
      a mixture of both, and
   the discrete nano-sized filler particles being present in an amount of 25 wt. % to 45 wt. %,
e. additives,
the curable composition not comprising the following components alone or in combination:
   aggregates of nano-sized filler particles,
   agglomerates of nano-sized filler particles,
   fumed silica,
each in an amount of 2 wt. % or more, wt. % with respect to the whole composition.

### Embodiment 3

A curable composition comprising, consisting essentially of, or consisting of
a. a (meth)acrylate not comprising a urethane moiety in an amount of 20 to 75 wt. %,
b. a urethane (meth)acrylate in an amount of 8 to 20 wt. %,
c. photo-initiator,
d. discrete nano-sized filler particles
   having an average particle size in the range of 10 to 40 nm, and
   having been surface treated with a surface treating agent comprising a (meth)acrylate moiety and a surface treating agent not comprising a (meth)acrylate moiety, wherein preferably the surface treating agent comprising a (meth)acrylate moiety is used in a higher amount with respect to weight compared to the surface treating agent not comprising a (meth)acrylate moiety,
   the discrete nano-sized filler particles being present in an amount of 25 wt. % to 45 wt. %,
e. additives,
the curable composition not comprising the following components alone or in combination:
   aggregates of nano-sized filler particles,
   agglomerates of nano-sized filler particles,
   fumed silica,
each in an amount of 2 wt. % or more, wt. % with respect to the whole composition.

The curable composition described in the present text can be produced by mixing the respective components under save-light conditions. If desired, a speed mixer can be used.

During storage the curable composition described in the present text is typically stored under save light conditions, in particular in a sealed container, vessel, or foil bag. The volume of the container may be in a range of 1 ml to 1 1.

The curable composition can be processed in an additive-manufacturing process for producing 3d-printed articles. The 3d-printing process is generally known to the skilled person.

An example of this kind of technology is described in U.S. Pat. No. 8,003,040 B2 (El-Siblani) relating to a process for producing a 3-dim object by solidifying layers with electromagnetic radiation of synergistic stimulation in a pattern.

In particular, so-called SLA or DLP 3d-priting processes were found to be useful. Technical equipment which can be used is commercially available e.g. from 3Shape, Rapid Shape, Formlabs, Lithoz, Prodways, Stratasys, Envision Tec and others.

The additive-manufacturing device works with a certain radiation wavelength, which is typically in the range of 350 to 500 nm.

The additive-manufacturing device can also be characterized by the resolution which can be achieved. A suitable resolution is typically in the range of 5 to 100 μm or 10 to 80 μm or 20 to 60 μm.

After conducting the additive-manufacturing process, the printed article can be post-processed, if desired.

Useful post-processing steps include cleaning and post-curing of the cleaned article.

The cleaning of the 3d-printed article can be done by using a cleaning solution and/or by conducting a so-called spin-cleaning process.

By conducting a cleaning step undesired residues of the curable resin remaining on the surface of the 3d-printed article can be removed.

Suitable cleaning solutions include alcohols such as ethanol or iso-propanol, esters of carboxylic acids such as di basic esters of a carboxylic acid and/or tri basic esters of a carboxylic acid, or mixtures thereof.

Suitable cleaning solutions are also described in WO 2018/222395 A1 (3M).

The spin-cleaning process includes the step of moving or rotating the 3-dimensional article. By doing this a mass inertial force is generated.

The term “mass inertial force” as referred to herein may be specified as force per unit mass and therefore may be specified in the unit m/s². Further, the mass inertial force can be expressed by the G-force which is a factor of the acceleration of gravity. For the purpose of the present text the acceleration of gravity is 9.81 m/s². Consequently, for example a mass inertial force of 9.81 m/s² can be expressed as 1 G.

The acceleration force or mass inertial force is induced by moving, for example rotating, the object.

The centrifugal force on a particle on the surface of the 3-dim article typically depends on the rotation speed and the radius at which that particle is located from the rotation axis.

By varying parameters such as speed of movement or rotation, the duration thereof and/or the rotation axis, this technique allows the adjustment of the amount and layer-thickness of the radiation-curable composition remaining on the surface of the 3-dimensional article.

In an embodiment the mass inertial force generated in the cleaning step corresponds to a G-force of at least 100 G. A mass inertial force of 100 G has proven to be suitable to remove a mid to high viscos radiation-curable material. The skilled person will recognize that the mass inertial force required for the cleaning step may be lower for lower viscos materials and higher for higher viscos materials. Such a process is described e.g. in WO 2019/023120 A1 (3M).

Post-curing typically comprises the step of applying heat or radiation to the 3d-prtinted article. If desired, the post-curing can be done under reduced pressure.

Conducting a post-curing step typically helps to further strengthen mechanical properties of the 3d-printed article.

The post-curing step can be characterized by the following features alone or in combination: applying radiation with wavelength of 350 to 500 nm: applying a heating step of 30 to 200° C. or from 40 to 150° C.

Devices which can be used for post-curing a 3-dimensional article obtained by additive-manufacturing are commercially available, e.g., from Rapidshape, 3Shape, EnvisonTEC, Formlabs and others.

The invention also relates to a cured composition or article obtained or obtainable by curing the curable composition described in the present text.

The cured composition can typically be characterized by the following features alone or in combination:
a. opalescence OP: less than 15, determined on a 1.0 mm thick sample:
b. flexural strength: 50 to 200 MPa, determined according to ISO 4049 (2019):
c. E-modulus: 1 to 4 GPa, determined according to DIN EN 843-2:2007.

A combination of the features a) and b): or a), b) and c) is sometimes preferred. If desired, the parameters can be determined as described in the example section.

An opalescence of less than 15% was found to be suitable for making the cured composition having e.g., the shape of an orthodontic article hardly visible in the mouth of a patient.

A flexural strength and/or E-modulus in the above-mentioned range was found to meet the practitioner's expectations for articles to be used in the orthodontic field with regard to mechanical properties.

The cured composition may have different shapes and dimensions.

The cured composition typically comprises a convex surface on the one side and a concave surface on the other side.

Suitable shapes include aligner attachments, orthodontic brackets, buccal tubes, class II and class III correctors, buttons, cleats, and other attachment devices, in particular aligner attachments.

The dimension (x, y, z-dimension) of the cured composition or article is typically in the range of 0.5 to 10 mm with respect to each of the dimensions.

The curable composition is particularly useful for producing orthodontic attachments for use in a so-called dental aligner therapy, that is a therapy or method for aligning teeth in the mouth of a patient.

Such a method typically comprises the following steps:
a. processing the curable composition in an additive-manufacturing process, optionally followed by post-processing steps such as cleaning and curing, to obtain a 3d-printed orthodontic attachment:
b. inserting the orthodontic attachment in a cavity of a dental positioning tray:
c. inserting the dental positioning tray into the mouth of a patient:
d. attaching the orthodontic attachment to the surface of a tooth to be aligned:
e. removing the dental positioning tray from the mouth of the patient:
f. optionally inserting a dental aligner tray in engagement with the orthodontic attachment.

The attaching and/or fixing of the orthodontic attachment to the tooth surface can be supported by using a dental adhesive. Suitable dental adhesives are commercially available, e.g. Scotchbond™ Universal (3M Oral Care). Suitable dental adhesives are also described in U.S. Pat. No. 11,160,733 B2 (Thalacker et al.) or U.S. Pat. No. 7,700,668 B2 (Thalacker et al.).

Alternatively, dental cements can be used. Suitable dental cements are commercially available, e.g. RelyX™ Unicem (3M Oral Care) or RelyX™ Universal (3M Oral Care). Suitable dental cements are also described in WO 2017/100231 A1 (3M) or U.S. Pat. No. 8,236,871 B2 (Hecht et al).

The invention also relates to a kit of part comprising a dental positioning tray, and either of the following: at least one cured composition having the shape of an orthodontic attachment as described in the present text, or at least one curable composition as described in the present text, and optionally a dental aligner tray.

A dental positioning tray is typically used for placing orthodontic attachments onto patients' teeth. An example of a dental positioning tray and related processes are described in US 2015/0313687 A1 (Blees et al.), US 2020/131356 A1 (Zech et al.).

A dental aligner tray is used to straighten teeth like braces. They use gentle and constant force to move teeth in the desired position. They are typically transparent and custom made.

The complete disclosures of the patents, patent documents, and publications cited herein are incorporated by reference in their entirety as if each were individually incorporated. Various modifications and alterations to this invention will become apparent to those skilled in the art without departing from the scope and spirit of this invention. The above specification, examples and data provide a description of the manufacture and use of the compositions and methods of the invention. The invention is not limited to the embodiments disclosed herein. One skilled in the art will appreciate that many alternative embodiments of the invention can be made without departing from the spirit and scope of thereof.

The following examples are given to illustrate the invention.

### EXAMPLES

Unless otherwise indicated, all parts and percentages are on a weight basis, all water is de-ionized water, and all molecular weights are weight average molecular weight. Moreover, unless otherwise indicated all experiments were conducted at ambient conditions (23° C.: 1013 mbar).

### Methods

### Viscosity

If desired, the viscosity can be measured with a Physica MCR 301 (Anton Paar Germany GmbH, Ostfildern-Scharnhausen) at 23.0° C. with a shear ramp between 0.1 s⁻¹ and of 1,000 s⁻¹ with a 25 mm plate/cone system.

### Transparency

If desired, the transparency can be determined with a sphere benchtop spectral photometer Color i7800 (x-rite, Michigan USA). For measuring the transparency, a sample of 1.0 mm in height and 15 mm in diameter is placed in between the sphere and the sensor with a specific transmission sample holder from x-rite. The parameters of the measurement: specular included, blend opening 10 mm, area of view 6 mm, wavelength between 360 nm to 780 nm in 10 nm steps. The transmission TR [%] is the mean of all transmission values in 10 nm steps between 400 nm and 700 nm through the sample in relation to a measurement without a sample in the light beam.

### Opalescence (OP)

If desired, opalescence can be determined with a sphere benchtop spectral photometer Color i7800 (x-rite, Michigan USA), applying the formula described above. The opalescence was measured with samples of 1.0 mm in height and 15 mm in diameter.

### Particle Size Distribution (Non Nano-Sized Particles)

If desired, the particle size can be measured using a Malvern Mastersizer 2000 (Malvern Instruments, Malvern, Worcestershire, UK) light scattering instrument. The Mastersizer 2000 uses an integrated optical system to cover the range from 0.02 to 2000 μm. The mixtures to be analysed is added to the test chamber filled with isopropanol until an obscuration of approximately 8-15% is reached. No ultrasound is applied in order not to alter the particle size distributions. The raw data is processed with the instrument software using a refractive index of 1.459 and applying the Mie correction together with the Fraunhofer approximation, frequently used techniques known to the expert.

### Particle Size Distribution (Nano-Sized Particles)

The measurement of the size of nano-particles is preferably based on a TEM (transmission electron microscopy) method, whereby a population is analysed to obtain an average particle diameter. A preferred method for measuring the particle diameter can be described as follows:

Samples approximately 80 nm thick are placed on 200 mesh copper grids with carbon stabilized formvar substrates (SPI Supplies-a division of Structure Probe, Inc., West Chester, PA). A transmission electron micrograph (TEM) is taken, using JEOL 200CX (JEOL, Ltd. of Akishima, Japan and sold by JEOL USA, Inc.) at 200 KV. A population size of about 50-100 particles can be measured and an average diameter is determined.

### Flexural Strength (FS)

If desired, the measurement of the flexural strength can be carried out according to ISO 4049 (2019) using a universal testing machine (Zwick Z 010, crosshead speed 1 mm/min) and test specimen having the size 2*2*25 mm. The flexural strength is typically given in MPa.

### E-Modulus (EM)

If desired, the E-M (I) can be determined according to ISO 4049 (2019) using a test bar having the dimensions 2*2*25 mm, with 6 mm being the width of the sample. The E-Modulus is determined between the range of 20% and 50% of the maximum force of the test specimen. E-Modulus is given in [GPa].

### Materials

The following material were used:

TABLE 1

| | Abbreviation | Description | Source |
|---|---|---|---|
| DESMA | U-MA | urethane | cf. synthesis of compound (A1) |
| | | methacrylate | of US 2011/0053116 Al (Hecht |
| | | | et al.) |
| D-Zethacrylate | MA | ethoxylated | |
| | | bisphenol A | |
| | | dimethacrylate | |
| Lucirin ™ TPO | PS | Photo-initiator | BaSF |
| MLumiluxBlau ™ LZ | Dye | Fluorescent dye | Honeywell |
| Tinuvin ™ 326 | ABS | Absorber | BASF |
| Ionol ™; 2,6-di- | STAB | Stabilizer | |
| tert•butyl-4- | | | |
| methylphenol | | | |
| Aerosil ™ OX50 | OX50 | Fumed silica | Evonik |
| HDK ™ H-2000 | HDKH | Fumed silica; | Wacker |
| | | surface treated | |
| Levasil ™ 50/50% | Nano-F1 | Discrete nano- | Kurt Obermeier GmbH |
| (average particle size | | sized filler | |
| 50 nm) | | particles | |
| Levasil ™ 200/40% | Nano-F2 | Discrete nano- | Kurt Obermeier GmbH |
| (average particle | | sized filler | |
| size 22 nm) | | particles | |
| Levasil ™ CS40-213 | Nano-F3 | Discrete nano- | Kurt Obermeier GmbH |
| (average particle | | sized filler | |
| size 15 nm) | | particles | |
| Zr/Si nano clusters | Nano- | Nano-clusters; | Zr/Si Nanocluster filler was |
| | Cluster | surface treated | produced as described in U.S. |
| | | | Pat. No. 6,730,156 B1, column 25, |
| | | | Preparatory Example A. The |
| | | | obtained filler particles were |
| | | | surface treated according to a |
| | | | process as described in |
| | | | Preparatory Example B of U.S. |
| | | | Pat. No. 6,730,156 B1. |
| 3-Methacryloxypropyl- | STA1 | Silane treating | Gustav Grolman GmbH Co. KG |
| trimethoxysilan (GF31) | | agent | |
| Phenyl trimethoxy | STA2 | Silane treating | Biesterfeld Spezialchemie GmbH |
| silane (PTMS) | | agent | |

### General Process for Producing Surface-Treated Discrete Nano-Sized Fillers

A sol containing nano-sized particles is mixed with the desired silane surface treating agent and stirred under reflux in a solvent like ethanol for several hours (e.g., 2 to 10 hrs). As appropriate, the (meth)acrylate component or parts thereof is added and the mixture is stirred for several hours again. The solvent is removed under reduced pressure.

### General Process for Producing Surface-Treated Fumed Silica

Fumed silica, silane and solvent are mixed with a stirrer for about 2 hrs. The dispersion is dried in an oven at ambient temperature until the solvent has evaporated. The dry fumed silica is screened with a 500 μm screen. The final condensation of silane to the surface of the fumed silica is done at above 100° C. for 3-4 hrs, followed by a final screening of the silane treated fumed silica with a 100 μm screen.

### General Process for Producing the Curable Composition

The respective components are mixed under save-light conditions using a speed mixer. In addition, the mixture is evacuated in a lab kneader.

The following compositions were produced:

TABLE 2

| | CE1 | CE2 | IE1 | IE2 | CE3 | CE4 |
|---|---|---|---|---|---|---|
| Comment | | Nano-F1 | Nano-F2 | Nano-F3 | | |
| | | (50 nm) | (22 nm) | (15 nm) | | |
| STA | STA1 | STA1 + | STA1 + | STA1 + | — | STA1 |
| | | STA2 | STA2 | STA2 | | |
| | | (80/20 | (80/20 | (80/20 | | |
| | | wt. %) | wt. %) | wt. %) | | |
| U-MA | 13.20 | 13.20 | 13.20 | 13.20 | 19.70 | 13.20 |
| MA | 52.86 | 52.86 | 52.86 | 52.86 | 78.80 | 52.84 |
| PS | 0.8 | 0.8 | 0.8 | 0.8 | 1.29 | 0.8 |
| Dye | 0.03 | 0.03 | 0.03 | 0.03 | 0.04 | 0.03 |
| ABS | 0.08 | 0.08 | 0.08 | 0.08 | 0.12 | 0.08 |
| STAB | 0.03 | 0.03 | 0.03 | 0.03 | 0.05 | 0.05 |
| Nano-Cluster | 30.5 | 0 | 0 | 0 | 0 | 0 |
| HDKH | 2.5 | 0 | 0 | 0 | 0 | 0 |
| OX50 | 0 | 0 | 0 | 0 | 0 | 33 |
| Nano Filler | 0 | 33 | 33 | 33 | 0 | 0 |
| Viscosity | 27.2 | 9.4 | 8.6 | 8.1 | 1.9 | 27.6 |
| (0.1/s) | | | | | | |
| [Pa*s] | | | | | | |
| Viscosity | 14.8 | 6.8 | 8.4 | 8.3 | 1.9 | 13.6 |
| (1/s) | | | | | | |
| [Pa*s] | | | | | | |
| Viscosity | 5.2 | 4.1 | 7.4 | 7.4 | 1.8 | 32.2 |
| (10/s) | | | | | | |
| [Pa*s] | | | | | | |
| Viscosity | 4.4 | 4.0 | 6.3 | 6.2 | 1.8 | — |
| (1,000/s) | | | | | | |
| [Pa*s] | | | | | | |

CE: Comparative Example;
IE: Inventive Example

General Process of Producing 3d-Printed Articles

### Additive Manufacturing Process:

The composition is poured into the working tray of a commercially available DLP printer (Rapidshape, Heimsheim, Germany). The pre-processing data (STL-file: shape of 3-dimensional cuboid object: 25 mm*2 mm*2 mm) is loaded into the printer. The following printing conditions can be applied: curing light wavelength: 360-420 nm light: curing light intensity: 5-100 W/m²: exposure time: 1-11 sec: layer thickness: 25 μm.

3-dimensional Article

The 3-dimensional article can be produced as follows: The composition is placed in a vat of an additive-manufacturing device. By using the parameters described above in the additive manufacturing process a 3-dimensional article is produced layer-by-layer. The 3-dimensional article had the shape of an orthodontic article. The 3-dimensional article was removed from the vat of the additive-manufacturing device.

### Cleaning Process:

The cleaning of the 3-dimensional article from excess material can be performed as described in WO 2019/023120 A1 (3M) using the parameters described in the text above.

### Post Curing Step

For the final curing of the 3-dimensional article a light curing device can be used that is able to emit light between 360 nm and 420 nm at 50-500 mW/cm². Light curing to full cure of the samples can be conducted under reduced pressure (in the range of 1-100 mbar), if desired. The obtained samples were evaluated with respect to their properties. The results are given in Table 3.

TABLE 3

| | CE1 | CE2 | IE1 | IE2 | CE3 | CE4 |
|---|---|---|---|---|---|---|
| Comment | Cluster | 50 nm | 22 nm | 15 nm | No filler | silica |
| TR [%] | 38.3 | 54.2 | 78.6 | 82.6 | 86.4 | 50.3 |
| FS [MPa] | 120 ± 10 | 127 ± 8 | 121 ± 9 | 114 ± 9 | 108 ± 3 | 138 ± 9 |
| EM [GPa] | 2.6 ± 0.1 | 2.5 ± 0.1 | 2.2 ± 0.2 | 2.0 ± 0.1 | 1.5 ± 0.1 | 2.8 ± 0.1 |

Pictures of samples CE1, CE2, IE1, IE2 and CE3 (from left to right) with the shape of an orthodontic article are shown in FIG. 2. The sample in the upper left corner corresponds to CE1, the sample in the lower right corner to CE3.

Sample CE1 is opaque and contains nano-cluster filler and fumed silica.

Sample CE2 contains discrete nano-filler particles, however, with an average particle size of about 50 nm. The sample is opalescent.

Sample CE3 is transparent and contains no filler.

Sample CE4 is opaque and contains fumed silica.

Samples IE1 and IE2 (inventive) contain discrete surface-treated nano-filler particles, however, with an average particle size in the range of 10 to 40 nm. The samples are transparent and not opalescent.

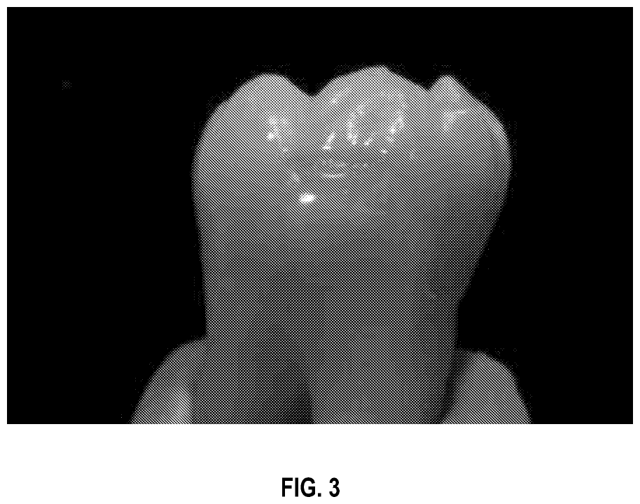

FIG. 3 shows sample IE1 attached to a tooth surface. Due to its transparency the sample is hardly visible on the tooth surface.

Using the curable composition described in the present text containing discrete filler nano-particles enables the manufacturing or small articles which are high transparent and nearly invisible on a tooth surface.

This contrasts with a formulation comprising nano-clusters (CE1) or commercially available flowable composite materials.

Surprisingly the transparency of the cured composition is even comparable to a formulation without any filler (CE3). In addition, the cured composition shows beneficial mechanical properties, such as flexural strength (after storage in water for 24h).

1. A curable composition comprising
a. a (meth)acrylate not comprising a urethane moiety in an amount of 20 to 75 wt. %,
b. a urethane (meth)acrylate in an amount of 5 to 25 wt. %,
c. photo-initiator in an amount of 0.01 to 5 wt. %,
d. discrete nano-sized filler particles in an amount of 20 to 50 wt. %, having an average particle size in the range of 10 to 40 nm,
having been surface treated with a silane surface treating agent selected from
a silane surface treating agent comprising a (meth)acrylate moiety,
a silane surface treating agent not comprising a (meth)acrylate moiety, and
a mixture of both, and
e. additives in an amount of 0.001 to 10 wt. %,
the curable composition not comprising filler particles other than those mentioned-above each in an amount of 2 wt. % or more, and not comprising polymerizable components comprising only one (meth)acrylate moiety in an amount of 1 wt. % or more, wt. % with respect to the curable composition
the discrete nano-sized filler particles being characterized by the following features alone or in combination: comprising oxides of Si, Zr, Al and mixtures thereof; having a specific BET surface of 80 m²/g or more.

2. The curable composition according to claim 1 being characterized by the following features alone or in combination:
viscosity: <50 Pa*s at 23° C. a shear rate of 1 s⁻¹;
curable by radiation having a wavelength in the range of 350 to 500 nm.

3. The curable composition according to claim 1, the photo-initiator having a light absorption peak in the range of 350 to 500 nm.

4. (canceled)

5. The curable composition according to claim 1, the surface treating agent comprising a (meth)acrylate moiety being characterized by the following formula: 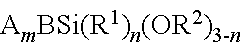
with A comprising a (meth)acryl moiety,
B comprising a spacer group, such as (i) linear or branched C₁ to C₁₂ alkyl, (ii) C₆ to C₁₂ aryl, (iii) organic group having 2 to 20 carbon atoms bonded to one another by one or more ether, thioether, ester, thioester, thiocarbonyl, amide, urethane, carbonyl and/or sulfonyl linkages,
R¹ comprising an alkyl group or an aryl group, and
R² comprising an alkyl group,
with m=1, 2, or 3, and n=0, 1 or 2.

6. The curable composition according to claim 1 the surface treating agent not comprising a polymerizable moiety being characterized by the following formula: 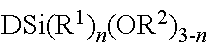
with D comprising (i) a linear or branched non-substituted or substituted C₁ to C₁₆ alkyl, (ii) a non-substituted or substituted C₆ to C₁₂ aryl group or (iii) an organic group having 2 to 20 carbon atoms bonded to one another by one or more ether, thioether, ester, thioester, thiocarbonyl, amide, urethane, carbonyl and/or sulfonyl linkages,
R¹ comprising a C₁ to C₆ alkyl group or a C₆ to C₁₂ aryl group, and
R² comprising a C₁ to C₆ alkyl group,
and n=0, 1 or 2.

7. The curable composition according to claim 1 the discrete nano-sized filler particles having been surface treated with a surface treating agent comprising a (meth)acrylate moiety and a surface treating agent not comprising a (meth)acrylate moiety, wherein preferably the surface treating agent comprising a (meth)acrylate moiety is used in a higher amount with respect to weight compared to the surface treating agent not comprising a (meth)acrylate moiety.

8. The curable composition according to claim 1 comprising the respective components in the following amounts:
methacrylate not comprising a urethane moiety: 25 to 70 wt. %,
urethane (meth)acrylates: 8 to 20 wt. %,
photo-initiator: 0.02 to 4 wt. %,
discrete surface treated nano-sized filler particles: 25 to 45 wt. %,
additives: 0.001 to 10 wt. %; wt. % with respect to the curable composition.

9. The curable composition according to claim 1, the curable composition not comprising polymerizable components comprising an acidic moiety; plasticizers; each in an amount of 1 wt. % or more, wt. % with respect to the curable composition.

10. A cured composition obtainable by curing the curable composition of claim 1.

11. The cured composition of claim 10 being characterized by the following features alone or in combination:
transparency: 60 to 85%, determined with light having a wavelength in the range of 400 to 700 nm on a 1 mm thick sample;
opalescence: less than 15, determined on a 1 mm thick sample;
flexural strength: 50 to 200 MPa determined according to ISO 4049 (2019);
E-modulus: 1 to 4 GPa, determined according to DIN EN 843-2:2007.

12. The cured composition according to any of claim 10 having the shape of an aligner attachment, orthodontic bracket, buccal tube, class II and class III corrector, button, or cleat.

13. (canceled)

14. (canceled)

15. A kit of parts comprising a dental positioning tray; and either at least one curable composition according to claim 1; or at least one cured composition according to claim 10; and optionally a dental aligner tray.
